(19) United States
(12) Patent Application Publication
(10) Pub. No.: US 2019/0208225 A1
(43) Pub. Date: Jul. 4, 2019

(54) SIGN PREDICTION IN VIDEO CODING

(71) Applicant: QUALCOMM Incorporated, San Diego, CA (US)

(72) Inventors: Yi-Wen Chen, San Diego, CA (US); Yung-Hsuan Chao, San Diego, CA (US); Wei-Jung Chien, San Diego, CA (US); Marta Karczewicz, San Diego, CA (US)

(21) Appl. No.: 16/225,393

(22) Filed: Dec. 19, 2018

Related U.S. Application Data
(60) Provisional application No. 62/612,946, filed on Jan. 2, 2018.

(51) Int. Cl. H04N 19/61; H04N 19/13; H04N 19/70; H04N 19/124; H04N 19/18; H04N 19/176

(52) U.S. Cl. CPC H04N 19/61; H04N 19/13; H04N 19/176; H04N 19/124; H04N 19/18; H04N 19/70

(57) ABSTRACT

A device for coding video data is configured to determine a predicted sign value for a transform coefficient of a current block of a current picture of the video data. The device may further determine, based on a quantized value for the transform coefficient being greater or less than a threshold, a Context Adaptive Binary Arithmetic Coding (CABAC) context. Additionally, the device may use the determined CABAC context to CABAC code a syntax element indicating whether the predicted sign value for the transform coefficient is correct.

This application claims the benefit of U.S. provisional patent application 62/612,946, filed Jan. 2, 2018, the entire content of which is incorporated by reference.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard, ITU-T H.265/High Efficiency Video Coding (HEVC), and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for transform coefficient sign bit prediction applied for residual coding of Intra- or Inter-coded blocks but may be extended to other prediction modes as well. Techniques of this disclosure may be used in the context of advanced video codecs, such as extensions of HEVC, the next generation of video coding standards, or other future generations of video coding standards. For example, the techniques described in this disclosure may be used with the versatile video coding (VVC) standard currently under development.

In one example, this disclosure describes a method of coding video data, the method comprising: determining a predicted sign value for a transform coefficient of a current block of a current picture of the video data; determining, based on a quantized value for the transform coefficient being greater or less than a threshold, a Context Adaptive Binary Arithmetic Coding (CABAC) context; and using the determined CABAC context to CABAC code a syntax element indicating whether the predicted sign value for the transform coefficient is correct.

In another example, this disclosure describes a device for coding video data, the device comprising: a memory to store the video data; and processing circuitry configured to: determine a predicted sign value for a transform coefficient of a current block of a current picture of the video data; determine, based on a quantized value for the transform coefficient being greater or less than a threshold, a Context Adaptive Binary Arithmetic Coding (CABAC) context; and use the determined CABAC context to CABAC code a syntax element indicating whether the predicted sign value for the transform coefficient is correct.

In another example, this disclosure describes a device for coding video data, the device comprising: means for determining a predicted sign value for a transform coefficient of a current block of a current picture of the video data; means for determining, based on a quantized value for the transform coefficient being greater or less than a threshold, a Context Adaptive Binary Arithmetic Coding (CABAC) context; and means for using the determined CABAC context to CABAC code a syntax element indicating whether the predicted sign value for the transform coefficient is correct.

In another example, this disclosure describes a computer-readable storage medium having stored thereon instructions that, when executed, cause one or more processors to: determine a predicted sign value for a transform coefficient of a current block of a current picture of the video data; determine, based on a quantized value for the transform coefficient being greater or less than a threshold, a Context Adaptive Binary Arithmetic Coding (CABAC) context; and use the determined CABAC context to CABAC code a syntax element indicating whether the predicted sign value for the transform coefficient is correct.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 is a conceptual diagram illustrating a coefficient scan based on coefficient groups in HEVC.

FIG. 3 is a conceptual diagram illustrating an example of costing a hypothesis reconstructed border.

FIG. 4 is a block diagram illustrating an example video encoder that may perform the techniques of this disclosure.

FIG. 5 is a block diagram illustrating an example video decoder that may perform the techniques of this disclosure.

FIG. 6 is a flowchart illustrating an example method for encoding a current block.

FIG. 7 is a flowchart illustrating an example method for decoding a current block.

FIG. 8 is a flowchart illustrating an example process for CABAC coding sign residual values in accordance with an example of this disclosure.

### DETAILED DESCRIPTION

Coefficient sign prediction is a technique in video coding in which video coders (e.g., video encoders and video decoders) predict the sign values (e.g., the positive or negative signs) of transform coefficients instead of the sign values being explicitly signaled in a bitstream. In coefficient signal prediction, the bitstream may include sign residual values that indicate whether predicted sign values are correct. A video decoder may use the sign residual values and the predicted sign values to reconstruct the actual sign values of transform coefficients. It may be more efficient to signal the sign residual values than the sign values themselves because the sign residual values are more likely to be all a single value (e.g., 0 or 1) than the sign values themselves. This property of the sign residual values may make Context-Adaptive Binary Arithmetic Coding (CABAC) encoded versions of the sign residual values smaller than CABAC encoded versions of the sign values themselves.

For example, there is a relatively high likelihood that the predicted sign value is correct. In accordance with CABAC coding, because there is a bias in the likelihood of whether the predicted sign value is correct or not (e.g., more than 50-50 whether predicted signal value is correct), this bias can be exploited to reduce the number of bits needed to signal whether the predicted sign value is correct or not as compared to the number of bits needed to signal the actual signal value, where no such bias is present.

As part of applying CABAC to a sign residual value, a video coder determines a coding context for the sign residual value. The coding context determined for the sign residual value specifies probabilities of the sign residual value being 0 or 1. The accuracy of the probabilities impacts compression performance of CABAC. For instance, the compression performance of CABAC is reduced if the probabilities of the determined coding context are inaccurate. It is therefore desirable to determine a coding context that accurately reflects the true probabilities. Previous techniques have required video coders to select a coding context for a sign residual value of a transform coefficient based on whether or not a dequantized version of the transform coefficient is lower or higher than a threshold.

Requiring video coders to select the coding context for a sign residual value of a transform coefficient based on whether the dequantized version of the transform coefficient is lower or higher than a threshold may force a video decoder to wait for the transform coefficient to be dequantized before being able to determine the sign residual value. This alone may be problematic because it may slow the decoding process. Additionally, the previous techniques CABAC decode a delta quantization parameter (QP) value that is used in a process to dequantize the transform coefficient. The delta QP value occurs in the bitstream after the sign residual values. Thus, the video coder would need to CABAC decode something later in the bitstream (i.e., the delta QP values) in order to CABAC decode something earlier in the bitstream (i.e., the sign residual values). This may introduce decoding errors or increase the complexity of the video decoder. In general, it is desirable to limit the complexity of the video decoder in order to reduce production costs and electricity consumption.

Examples described in this disclosure may improve the process of determining coding contexts for use in CABAC coding sign residual values by avoiding at least the issues described above, thereby potentially accelerating the decoding process, avoiding decoding errors, and limiting the complexity of the video decoder. In one example, a video decoder may determine a predicted sign value for a transform coefficient of a current block of a current picture of the video data. Furthermore, in this example, the video decoder may determine, based on a quantized value for the transform coefficient being greater or less than a threshold, a CABAC context. In this example, the video decoder may use the determined CABAC context to CABAC code a syntax element indicating whether the predicted sign value for the transform coefficient is correct.

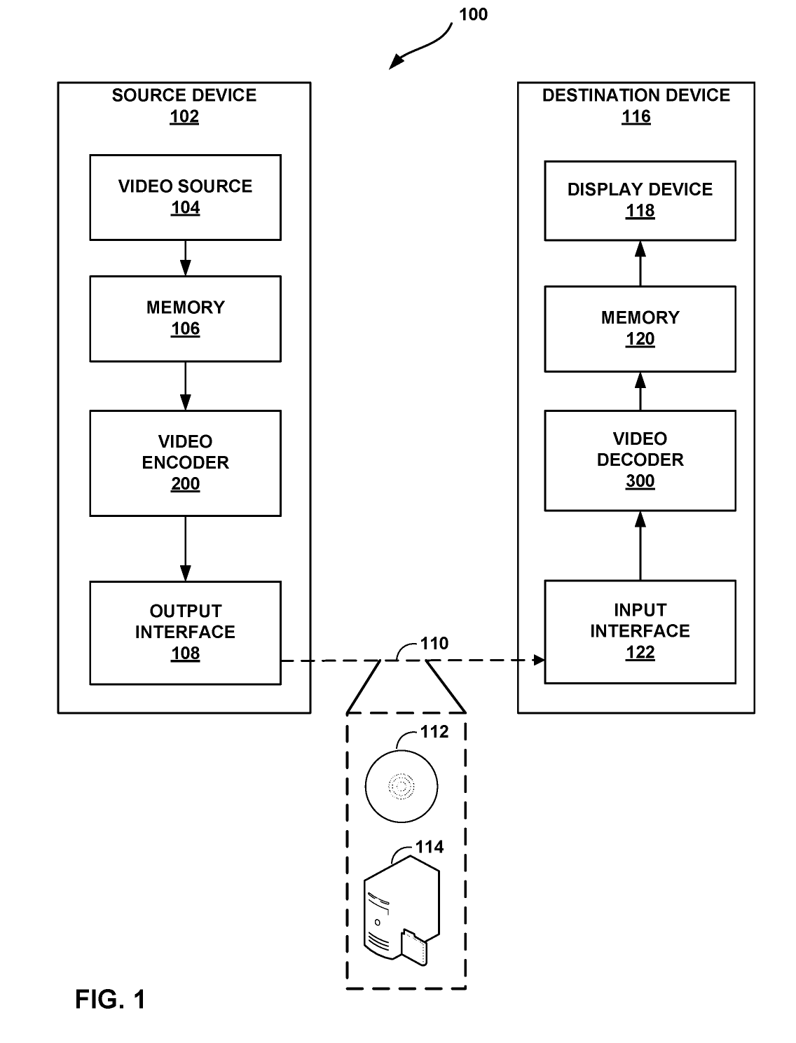

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, uncoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may comprise any of a wide range of devices, including desktop computers, notebook (i.e., laptop) computers, tablet computers, set-top boxes, telephone handsets such smartphones, televisions, cameras, display devices, digital media players, video gaming consoles, video streaming device, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for transform coefficient sign bit prediction applied for Intra or Inter coded blocks. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than including an integrated display device.

System 100 as shown in FIG. 1 is merely one example. In general, any digital video encoding and/or decoding device may perform techniques for transform coefficient sign bit prediction applied for Intra or Inter coded blocks. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, devices 102, 116 may operate in a substantially symmetrical manner such that each of devices 102, 116 includes video encoding and decoding components. Hence, in some examples, system 100 may support one-way or two-way video transmission between video devices 102, 116, e.g., for video streaming, video playback, video broadcasting, or video telephony.

In general, video source 104 represents a source of video data (i.e., raw, uncoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including an encoded representation of video data (i.e., encoded video data). Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some example, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may modulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video generated by source device 102. Destination device 116 may access stored video data from file server 114 via streaming or download. File server 114 may be any type of server device capable of storing encoded video data and transmitting that encoded video data to the destination device 116. File server 114 may represent a web server (e.g., for a website), a File Transfer Protocol (FTP) server, a content delivery network device, or a network attached storage (NAS) device. Destination device 116 may access encoded video data from file server 114 through any standard data connection, including an Internet connection. This may include a wireless channel (e.g., a Wi-Fi connection), a wired connection (e.g., DSL, cable modem, etc.), or a combination of both that is suitable for accessing encoded video data stored on file server 114. File server 114 and input interface 122 may be configured to operate according to a streaming transmission protocol, a download transmission protocol, or a combination thereof.

Output interface 108 and input interface 122 may represent wireless transmitters/receiver, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., storage device 112, file server 114, or the like). The encoded video bitstream computer-readable medium 110 may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a cathode ray tube (CRT), a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream. If applicable, MUX-DEMUX units may conform to the ITU H.223 multiplexer protocol, or other protocols such as the user datagram protocol (UDP).

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may comprise an integrated circuit, a microprocessor, and/or a wireless communication device, such as a cellular telephone.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Wang et al., “High Efficiency Video Coding (HEVC) Defect Report,” Joint Collaborative Team on Video Coding (JCT-VC) of ITU-T SG 16 WP 3 and ISO/IEC JTC 1/SC 29/WG 11, 14^{th} Meeting, Vienna, AT, 25 Jul.-2 Aug. 2013, document JCTVC-N1003_v1, is an HEVC draft specification, and referred to as HEVC WD hereinafter, and is available from http://phenix.int-evry.fr/jct/doc_end_user/documents/14_Vienna/wg11/JCTVC-N1003-v1.zip.

ITU-T VCEG (Q6/16) and ISO/IEC MPEG (JTC 1/SC 29/WG 11) are now studying the potential need for standardization of future video coding technology with a compression capability that significantly exceeds that of the current HEVC standard (including its current extensions and near-term extensions for screen content coding and high-dynamic-range coding). The groups are working together on this exploration activity in a joint collaboration effort known as the Joint Video Exploration Team (JVET) to evaluate compression technology designs proposed by their experts in this area. The JVET first met during 19-21 Oct. 2015. Jianle Chen et al., “Algorithm description of Joint Exploration Test Model 3,” Joint Video Exploration Team (JVET) of ITU-T SG 16 WP 3 and ISO/IEC JTC 1/SC 29/WG 11, 3^{rd} Meeting, Geneva, CH, 26 May-1 Jun. 2016, document JVET-C1001 v3 (hereinafter, “JEM3”) is an algorithm description of the Joint Exploration Test Model (JEM). The JVET has now moved into the process of developing Versatile Video Coding (VVC) based on the JEM. Video encoder 200 and video decoder 300 may operate according to the JEM or VVC. Alternatively, video encoder 200 and video decoder 300 may operate according to other proprietary or industry standards. The techniques of this disclosure, however, are not limited to any particular coding standard.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 partition a picture into a plurality of coding tree units (CTUs). Video encoder 200 may partition a CTU according to a tree structure, such as a quadtree-binary tree (QTBT) structure. The QTBT structure of JEM removes the concepts of multiple partition types, such as the separation between CUs, PUs, and TUs of HEVC. A QTBT structure of JEM includes two levels: a first level partitioned according to quadtree partitioning, and a second level partitioned according to binary tree partitioning. A root node of the QTBT structure corresponds to a CTU. Leaf nodes of the binary trees correspond to coding units (CUs).

In some examples, video encoder 200 and video decoder 300 may use a single QTBT structure to represent each of the luminance and chrominance components, while in other examples, video encoder 200 and video decoder 300 may use two or more QTBT structures, such as one QTBT structure for the luminance component and another QTBT structure for both chrominance components (or two QTBT structures for respective chrominance components).

Video encoder 200 and video decoder 300 may be configured to use quadtree partitioning, QTBT partitioning, or other partitioning structures. For purposes of explanation, the description of the techniques of this disclosure is presented with respect to QTBT partitioning. However, it should be understood that the techniques of this disclosure may also be applied to video coders configured to use quadtree partitioning, or other types of partitioning as well.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may comprise N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

JEM may also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. For example, JEM provides sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the coefficients, providing further compression. By performing the quantization process, video encoder 200 may reduce the bit depth associated with some or all of the coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

A bitstream may comprise a sequence of network abstraction layer (NAL) units. A NAL unit is a syntax structure containing an indication of the type of data in the NAL unit and bytes containing that data in the form of a raw byte sequence payload (RBSP) interspersed as necessary with emulation prevention bits. Each of the NAL units may include a NAL unit header and may encapsulate a RB SP. The NAL unit header may include a syntax element indicating a NAL unit type code. The NAL unit type code specified by the NAL unit header of a NAL unit indicates the type of the NAL unit. A RB SP may be a syntax structure containing an integer number of bytes that is encapsulated within a NAL unit. In some instances, an RBSP includes zero bits.

As noted above, a bitstream may include a representation of encoded pictures of the video data and associated data. The associated data may include parameter sets. NAL units may encapsulate RBSPs for VPSs, SPS, and PPS). A VPS is a syntax structure comprising syntax elements that apply to zero or more entire coded video sequences (CVSs). An SPS is also a syntax structure comprising syntax elements that apply to zero or more entire CVSs. An SPS may include a syntax element that identifies a VPS that is active when the SPS is active. Thus, the syntax elements of a VPS may be more generally applicable than the syntax elements of an SPS. A PPS is a syntax structure comprising syntax elements that apply to zero or more coded pictures. A PPS may include a syntax element that identifies an SPS that is active when the PPS is active. A slice header of a slice segment may include a syntax element that indicates a PPS that is active when the slice segment is being coded.

As mentioned above, video encoder 200 and video decoder 300 may apply CABAC encoding and decoding to values of syntax elements. To apply CABAC encoding to a syntax element, video encoder 200 may binarize the value of the syntax element to form a series of one or more bits, which are referred to as “bins.” In addition, video encoder 200 may identify a coding context, which may also be referred to as a “CABAC context.” The coding context may identify probabilities of bins having particular values. For instance, a coding context may indicate a 0.7 probability of coding a 0-valued bin and a 0.3 probability of coding a 1-valued bin. After identifying the coding context, video encoder 200 may divide an interval into a lower sub-interval and an upper sub-interval. One of the sub-intervals may be associated with the value 0 and the other sub-interval may be associated with the value 1. The widths of the sub-intervals may be proportional to the probabilities indicated for the associated values by the identified coding context. If a bin of the syntax element has the value associated with the lower sub-interval, the encoded value may be equal to the lower boundary of the lower sub-interval. If the same bin of the syntax element has the value associated with the upper sub-interval, the encoded value may be equal to the lower boundary of the upper sub-interval. To encode the next bin of the syntax element, video encoder 200 may repeat these steps with the interval being the sub-interval associated with the value of the encoded bit. When video encoder 200 repeats these steps for the next bin, video encoder 200 may use modified probabilities based on the probabilities indicated by the identified coding context and the actual values of bins encoded.

When video decoder 300 performs CABAC decoding on a value of a syntax element, video decoder 300 may identify a coding context. Video decoder 300 may then divide an interval into a lower sub-interval and an upper sub-interval. One of the sub-intervals may be associated with the value 0 and the other sub-interval may be associated with the value 1. The widths of the sub-intervals may be proportional to the probabilities indicated for the associated values by the identified coding context. If the encoded value is within the lower sub-interval, video decoder 300 may decode a bin having the value associated with the lower sub-interval. If the encoded value is within the upper sub-interval, video decoder 300 may decode a bin having the value associated with the upper sub-interval. To decode a next bin of the syntax element, video decoder 300 may repeat these steps with the interval being the sub-interval that contains the encoded value. When video decoder 300 repeats these steps for the next bin, video decoder 300 may use modified probabilities based on the probabilities indicated by the identified coding context and the decoded bins. Video decoder 300 may then de-binarize the bins to recover the value of the syntax element.

In some instances, video encoder 200 may encode bins using bypass CABAC coding. It may be computationally less expensive to perform bypass CABAC coding on a bin than to perform regular CABAC coding on the bin. Furthermore, performing bypass CABAC coding may allow for a higher degree of parallelization and throughput. Bins encoded using bypass CABAC coding may be referred to as “bypass bins.” Grouping bypass bins together may increase the throughput of video encoder 200 and video decoder 300. The bypass CABAC coding engine may be able to code several bins in a single cycle, whereas the regular CABAC coding engine may be able to code only a single bin in a cycle. The bypass CABAC coding engine may be simpler because the bypass CABAC coding engine does not select contexts and may assume a probability of ½ for both symbols (0 and 1). Consequently, in bypass CABAC coding, the intervals are split directly in half.

As described in V Sze et al., “High Efficiency Video Coding (HEVC): Algorithms and Architectures”, Springer (2014), the quantization step size (and therefore the QP value) may need to be changed within a picture for e.g. rate control and perceptual quantization purposes. HEVC allows for transmission of a delta QP value at a quantization group (QG) level to allow for QP changes within a picture. This is similar to H.264/AVC that allows for modification of QP values at a macroblock level. The QG size is a multiple of coding unit size that can vary from 8×8 to 64×64 depending on the CTU size and the syntax element diff_cu_qp_delta_depth.

The delta QP is transmitted only in CUs with non-zero transform coefficients. If the CTU is split into coding units that are greater than the QG size, then delta QP is signaled at a CU (with non-zero transform coefficients) that is greater than the QG size. If the CTU is split into CUs that are smaller than the QG size, then the delta QP is signaled in the first CU with non-zero transform coefficients in the QG. If a QG has coding units with all zero transform coefficients (e.g., if the merge mode is used in all the coding units of the QG), then delta QP will not be signaled.

The QP predictor used for calculating the delta QP uses a combination of QP values from the left, above and the previous QG in decoding order. The QP predictor uses a combination of two predictive techniques: spatial QP prediction (from left and above QGs) and previous QP prediction. It uses spatial prediction from left and above within a CTU and uses the previous QP as predictor at the CTU boundary. The spatially adjacent QP values, QPLEFT and QPABOVE are considered to be not available when they are in a different CTU or if the current QG is at a slice/tile/picture boundary. When a spatially adjacent QP value is not available, it is replaced with the previous QP value, QPPREV, in decoding order. The previous QP, QPPREV, is initialized to the slice QP value at the beginning of the slice, tile or wavefront.

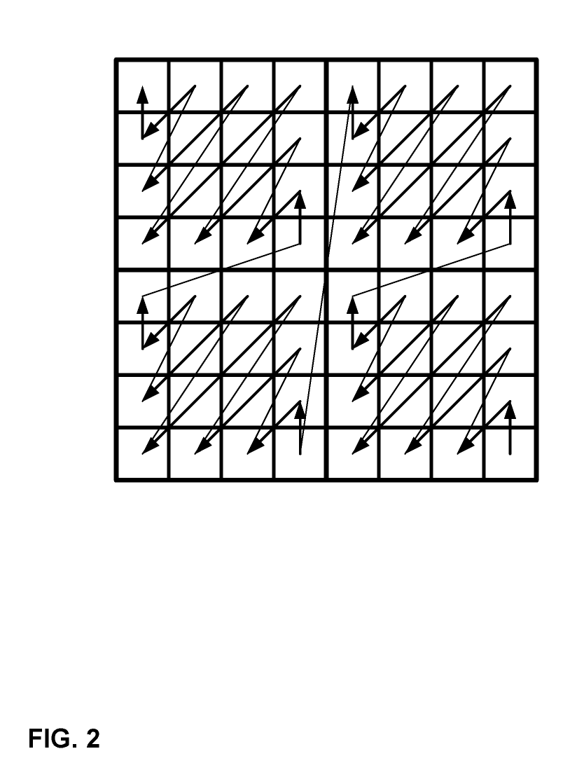

In HEVC transform coefficient coding, a transform coefficient block (TB) is first divided by coefficient groups (CG), and each CG represents a 4×4 sub-block. For example, a 32×32 TU has totally 64 CGs, and a 16×16 TU has totally 16 CGs. The entropy coding of the TB is performed in a unit of CG. The CGs inside a TB are coded according to a given scan order. When coding each CG, the coefficients inside the current CG are scanned and coded according to a certain pre-defined scan order for a 4×4 block. In JEM, the CG size could be either 4×4 or 2×2 depending on whether the height or width of one TB is equal to 2. FIG. 2 illustrates the coefficient scan for an 8×8 TB containing 4 CGs in HEVC.

For each color component, one flag may be firstly signaled to indicate whether the current TB has at least one non-zero coefficient. If there is at least one non-zero coefficient, the position of the last significant coefficient in the coefficient scan order in a TB is then explicitly coded with a coordination relative to the top-left corner of the TB. The vertical or horizontal component of the coordination is represented by its prefix and suffix, wherein the prefix is binarized with truncated rice (TR) and suffix is binarized with fixed length.

With such a position coded and also the coefficient scanning order of the CGs, one flag is further signaled for CGs except the last CG (in scanning order) which indicates whether it contains non-zero coefficients.

For those CGs that may contain non-zero coefficients, significant flags, absolute values of coefficients and sign information of non-zero coefficients are further coded for each coefficient according to the pre-defined 4×4 coefficient scan order. In the HEVC transform coefficient entropy coding scheme, the sign bit, if coded, is always bypass coded, i.e., no context is applied and 1 bit is always coded for each sign bit using an equal probability (EP) assumption.

For each CG, and depending on a criterion, encoding the sign of the last nonzero coefficient (in reverse scan order) which is the first nonzero coefficient in the forward scan order is simply omitted when using sign data hidding (SDH). Instead, the sign value is embedded in the parity of the sum of the levels of the CG using a predefined convention: even corresponds to “+” and odd to “−.” The criterion to use SDH is the distance in scan order between the first and the last nonzero coefficients of the CG. If this distance is equal or larger than 4, SDH is used. This value of 4 was chosen because it provides the largest gain on HEVC test sequences.

To improve the coding efficiency for sign bit information, coefficient sign prediction methods have been proposed in the literature. For example, Felix Henry, Gordon Clare, “Residual Coefficient Sign Prediction,” Joint Video Exploration Team (WET) of ITU-T SG 16 WP 3 and ISO/IEC JTC 1/SC 29/WG 11, Doc. WET-D0031, Oct. 2016, (hereinafter, “JVET-D0031”) describes a sign prediction method on top of JEM.

Basically, to predict the sign for one coefficient, the TB is reconstructed using both positive value and negative value for the sign of the coefficient, and each block reconstruction using a candidate sign value is called a hypothesis reconstruction. The two hypothesis reconstructions (e.g., one hypothesis reconstruction being for positive sign and other for negative sign) are evaluated by a given spatial-domain cost function, and the hypothesis reconstruction (e.g., one of positive value or negative value for the coefficient) that minimizes the cost function gives the predicted sign value.

Furthermore, to predict multiples signs for a TB, e.g., N signs, the TB is reconstructed using different combinations of candidate sign prediction values, which includes totally 2^{N} different hypothesis reconstructions. Similarly, each hypothesis is evaluated by a given spatial-domain cost function, and the hypothesis which minimizes the cost function gives the predicted sign value combination.

The cost function is typically measuring spatial discontinuity between previously reconstructed neighbor pixels and the currently tested reconstructed block using one of the hypotheses. The hypothesis which shows most smooth pixel value transition at the block boundary of the current block is considered to be the best prediction. For example, in NET-D0031, the cost is measured using the leftmost and topmost pixels of a hypothesis reconstruction.

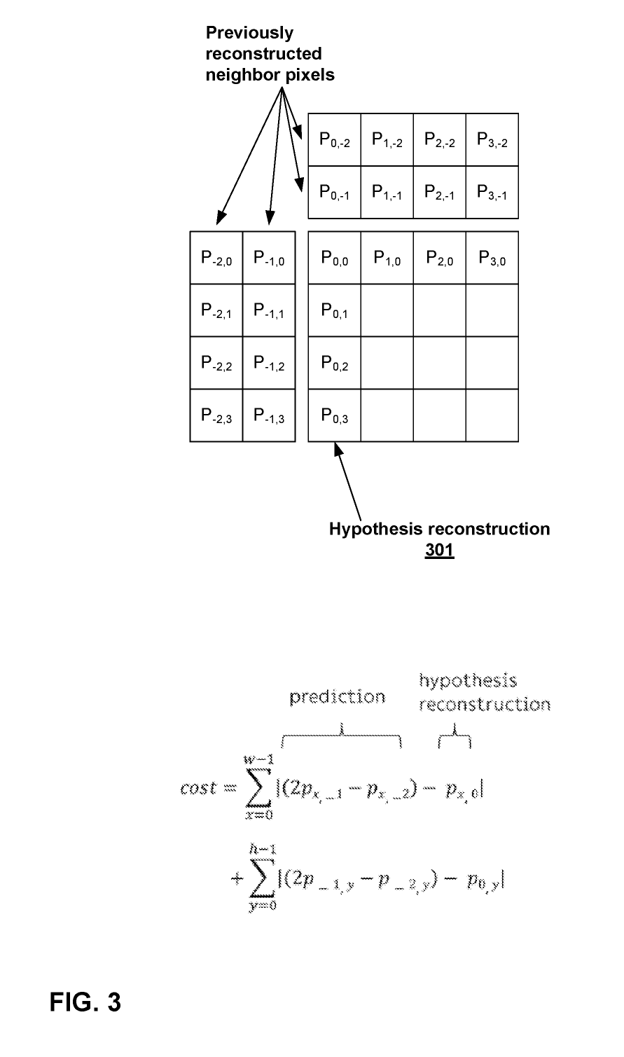

FIG. 3 is a conceptual diagram illustrating an example of costing a hypothesis reconstructed border. In the example of FIG. 3, a video coder generates a hypothesis reconstruction 301. Hypothesis reconstruction 301 is a block of reconstructed samples. The video coder may determine the reconstructed samples in hypothesis reconstruction 301 by determining a combination of candidate sign values, setting the sign values of quantized coefficients signaled in the bitstream according to the determined combination of candidate sign values, inverse quantizing transform coefficients, applying an inverse transform to the transform coefficients to determine predictive sample values, and adding the predictive sample values to residual sample values. The video coder may generate multiple hypothesis reconstructions in the same manner by using different combinations of candidate sign values. In the example of FIG. 3, the reconstructed samples include the leftmost and topmost pixels of hypothesis reconstruction 301, which are labeled P_{0,0}, P_{1,0}, P_{2,0}, P_{3,0}, P_{0,1}, P_{0,2}, and P_{0,3}. After generating hypothesis reconstruction 301, the video coder may determine a cost value associated with hypothesis reconstruction 301. The video coder may determine the cost value associated with hypothesis reconstruction 301 based on reconstructed samples in hypothesis reconstruction 301 and previously reconstructed neighbor pixels, e.g., according to the following equation:

$$cost = {\sum }_{x = 0}^{w - 1} \vert ( 2 {p}_{x , - 1} - {p}_{x , - 2} ) - {p}_{x , 0} \vert + {\sum }_{y = 0}^{h - 1} \vert ( 2 {p}_{- 1 , y} - {p}_{- 2 , y} ) - {p}_{0 , y} \vert \qquad ( 1 )$$

In the equation above |•| indicates the absolute value operator, w indicates a width of hypothesis reconstruction 301, and h indicates a height of hypothesis reconstruction 301. As shown in the example of FIG. 3, the term (2p_{x,-1}−p_{x,-2}) is a prediction of the expected difference between previously-reconstructed neighbor sample p_{x,-1} and sample p_{x,0} in hypothesis reconstruction 301. Similarly, the term (2p_{-1,y}−p_{-2,y},) is a prediction of the expected difference between previously-reconstructed neighbor sample p_{-1,y} and sample p_{0,y} in hypothesis reconstruction 301.

In a sign prediction scheme described in JVET-D0031, the video encoder initially dequantizes the TU (e.g., dequantizes transform coefficients of the TU) and then chooses n coefficients for which signs will be predicted. As described in JVET-D0031, the video encoder scans coefficients in raster-scan order, and dequantized values over a defined threshold are preferred over values lower than that threshold when collecting the n coefficients to treat. With these n values, 2ⁿ simplified border reconstructions are performed as described below, with one reconstruction per unique combination of signs for the n coefficients.

To reduce the complexity of performing sign prediction, a template-based hypothesis reconstruction is performed. For a particular hypothesis reconstruction, a video coder (e.g., video encoder 200 or video decoder 300) recreates only the leftmost and topmost pixels of the block from the inverse transformation added to the block prediction. Although the first (vertical) inverse transform is complete, the second (horizontal) inverse transform only has to create the leftmost and topmost pixel outputs and is thus faster. That is, a video coder may apply a transform (or inverse transform) that comprises two passes. The first pass processes columns of values to generate a block of intermediate values. The second pass processes rows of intermediate values in the block of intermediate values to generate final values. In this example, the video coder may perform the first pass completely, but may only need to apply the second pass to the intermediate values in the top row of the block of intermediate values and the first intermediate values of each row of the block of intermediate values. In this way, the video coder may avoid applying the second pass to intermediate values that are not in the left column and top row of the block of intermediate values. An additional flag, “topLeft”, has been added to inverse transform functions to allow this.

In addition, the number of inverse transform operations performed may be reduced by using a system of “templates.” In this way, when predicting n signs in a block, a video coder may only perform n+1 inverse transform operations. In examples where the video coder uses templates, the video coder may perform the following steps:
1. A single inverse transform operating on the dequantized coefficients, where the values of all signs being predicted are set positive. Once added to the prediction of the current block, this corresponds to the border reconstruction for the first hypothesis.
2. For each of the n coefficients having their signs predicted, an inverse transform operation is performed on an otherwise empty block containing the corresponding dequantized (and positive) coefficient as its only non-null element. The leftmost and topmost border values are saved in what is termed a ‘template’ for use during later reconstructions.

Border reconstruction for a later hypothesis starts by taking an appropriate saved reconstruction of a previous hypothesis which only needs a single predicted sign to be changed from positive to negative in order to construct the desired current hypothesis. This change of sign is then approximated by the doubling and subtraction from the hypothesis border of the template corresponding to the sign being predicted. The border reconstruction, after costing, is then saved if the border reconstruction is known to be reused for constructing later hypotheses.

TABLE 1

| Template Name | How to Create |
|---|---|
| T001 | inverse transform single positive 1^{st} sign-hidden |
| | coefficient |
| T010 | inverse transform single positive 2^{nd} sign-hidden |
| | coefficient |
| T100 | inverse transform single positive 3^{rd} sign-hidden |
| | coefficient |

TABLE 2

| Hypothesis | How to Create | Store for later reuse as |
|---|---|---|
| H000 | inverse transform all | H000 |
| | coefficients, add to prediction | |
| H001 | H000 - 2*T001 | |
| H010 | H000 - 2*T010 | H010 |
| H011 | H010 - 2*T001 | |
| H100 | H000 - 2*T100 | H100 |
| H101 | H100 - 2*T001 | |
| H110 | H100 - 2*T010 | H110 |
| H111 | H110 - 2*T001 | |

Tables 1 and 2 above show save/restore and template application for a 3-sign, 8-entry case. In other words, the video coder generates 3 templates, one for each of the 3 transform coefficients whose sign values will be predicted. In the context of Table 1 and Table 2, transform coefficients may be referred to as “sign-hidden” coefficients if their signs are predicted and therefore not signaled directly in the bitstream. To generate a template for a transform coefficient, the video coder may apply an inverse transform to a block that contains the transform coefficient and with all other values set to null (e.g., 0). In Tables 1 and 2 above, the templates are named T001, T010, and T100. The video coder may then generate 8 hypothesis reconstructions: H000, H001, H010, H011, H100, H101, H110, and H111. In other versions of this example, the video coder may generate different numbers of templates and hypothesis reconstructions. The video coder may then apply the cost function and select a hypothesis reconstruction as described in other examples. These approximations (i.e., hypothesis reconstructions) are used only during the process of sign prediction, not during final reconstruction.

Furthermore, for each of the transform coefficients whose signs are being predicted, a video encoder (e.g., video encoder 200) may determine whether the sign of the transform coefficient that was used to generate the selected hypothesis reconstruction for the transform coefficient is correct. The sign residual value for the transform coefficient indicates whether the prediction of the sign of the transform coefficient is correct. The sign residual value for a transform coefficient may be equal to 0 (indicating no difference) when the prediction of the sign of the transform coefficient is correct. For example, video encoder 200 may determine the sign residual values for the 3 sign-hidden coefficients of Table 1 and Table 2 above as follows:
If the video encoder selects hypothesis reconstruction H000 (i.e., the hypothesis reconstruction generated with the assumption that all transform coefficients of the block are positive), the video encoder sets the sign residual value for the 1^{st} sign-hidden transform coefficient to 0 if the 1^{st} sign-hidden transform coefficient is actually positive and 1 otherwise; sets the sign residual value for the 2^{nd} sign-hidden transform coefficient to 0 if the 2^{nd} sign-hidden transform coefficient is actually positive and 1 otherwise; and sets the sign residual value for the 3^{rd} sign-hidden transform coefficient to 0 if the 3^{rd} sign-hidden transform coefficient is actually positive and 1 otherwise.
If the video encoder selects hypothesis reconstruction H001, the video encoder sets the sign residual value for the 1^{st} sign-hidden transform coefficient to 0 if the 1^{st} sign-hidden transform coefficient is actually negative and 1 otherwise; sets the sign residual value for the 2^{nd} sign-hidden transform coefficient to 0 if the 2^{nd} sign-hidden transform coefficient is actually positive and 1 otherwise; and sets the sign residual value for the 3^{rd} sign-hidden transform coefficient to 0 if the 3^{rd} sign-hidden transform coefficient is actually positive and 1 otherwise.
If the video encoder selects hypothesis reconstruction H010, the video encoder sets the sign residual value for the 1^{st} sign-hidden transform coefficient to 0 if the 1^{st} sign-hidden transform coefficient is actually positive and 1 otherwise; sets the sign residual value for the 2^{nd} sign-hidden transform coefficient to 0 if the 2^{nd} sign-hidden transform coefficient is actually negative and 1 otherwise; and sets the sign residual value for the 3^{rd} sign-hidden transform coefficient to 0 if the 3^{rd} sign-hidden transform coefficient is actually positive and 1 otherwise.
If the video encoder selects hypothesis reconstruction H011, the video encoder sets the sign residual value for the 1^{st} sign-hidden transform coefficient to 0 if the 1^{st} sign-hidden transform coefficient is actually negative and 1 otherwise; sets the sign residual value for the 2^{nd} sign-hidden transform coefficient to 0 if the 2^{nd} sign-hidden transform coefficient is actually negative and 1 otherwise; and sets the sign residual value for the 3^{rd} sign-hidden transform coefficient to 0 if the 3^{rd} sign-hidden transform coefficient is actually positive and 1 otherwise.
If the video encoder selects hypothesis reconstruction H100, the video encoder sets the sign residual value for the 1^{st} sign-hidden transform coefficient to 0 if the 1st sign-hidden transform coefficient is actually positive and 1 otherwise; sets the sign residual value for the 2^{nd} sign-hidden transform coefficient to 0 if the 2^{nd} sign-hidden transform coefficient is actually positive and 1 otherwise; and sets the sign residual value for the 3^{rd} sign-hidden transform coefficient to 0 if the 3^{rd} sign-hidden transform coefficient is actually negative and 1 otherwise.
If the video encoder selects hypothesis reconstruction H101, the video encoder sets the sign residual value for the 1^{st} sign-hidden transform coefficient to 0 if the 1st sign-hidden transform coefficient is actually negative and 1 otherwise; sets the sign residual value for the 2^{nd} sign-hidden transform coefficient to 0 if the 2^{nd} sign-hidden transform coefficient is actually positive and 1 otherwise; and sets the sign residual value for the 3^{rd} sign-hidden transform coefficient to 0 if the 3rd sign-hidden transform coefficient is actually negative and 1 otherwise.
If the video encoder selects hypothesis reconstruction H110, the video encoder sets the sign residual value for the 1^{st} sign-hidden transform coefficient to 0 if the 1^{st} sign-hidden transform coefficient is actually positive and 1 otherwise; sets the sign residual value for the 2^{nd} sign-hidden transform coefficient to 0 if the 2^{nd} sign-hidden transform coefficient is actually negative and 1 otherwise; and sets the sign residual value for the 3^{rd} sign-hidden transform coefficient to 0 if the 3rd sign-hidden transform coefficient is actually negative and 1 otherwise.
If the video encoder selects hypothesis reconstruction H111, the video encoder sets the sign residual value for the 1^{st} sign-hidden transform coefficient to 0 if the 1^{st} sign-hidden transform coefficient is actually negative and 1 otherwise; sets the sign residual value for the 2^{nd} sign-hidden transform coefficient to 0 if the 2nd sign-hidden transform coefficient is actually negative and 1 otherwise; and sets the sign residual value for the 3^{rd} sign-hidden transform coefficient to 0 if the 3^{rd} sign-hidden transform coefficient is actually negative and 1 otherwise.

After determining the sign residual values for the sign-hidden transform coefficients, the video encoder may CABAC encode the sign residual values and include the CABAC-encoded sign residual values in the bitstream. A video decoder (e.g., video decoder 300) may CABAC decode the sign residual values in the bitstream. The video decoder may then perform the process set forth above to select a hypothesis reconstruction. Then, for each of the sign-hidden transform coefficients, the video decoder may set the sign of the sign-hidden transform coefficient based on whether the combination of signs associated with the selected hypothesis reconstruction is correct. For example, the video decoder may set the sign value of the 3 sign-hidden coefficients of Table 1 and Table 2 above as follows:
If the video decoder selects hypothesis reconstruction H000 (i.e., the hypothesis reconstruction generated with the assumption that all transform coefficients of the block are positive), the video decoder sets the sign value for the 1^{st} sign-hidden transform coefficient to positive if the sign residual value of the 1^{st} sign-hidden transform coefficient is 0 and negative otherwise; sets the sign value for the 2^{nd} sign-hidden transform coefficient to positive if the sign residual value of the 2nd sign-hidden transform coefficient is 0 and negative otherwise; and sets the sign value for the 3^{rd} sign-hidden transform coefficient to positive if the sign residual value of the 3^{rd} sign-hidden transform coefficient is 0 and negative otherwise.
If the video decoder selects hypothesis reconstruction H001, the video decoder sets the sign value for the 1^{st} sign-hidden transform coefficient to negative if the sign residual value of the 1^{st} sign-hidden transform coefficient is 0 and positive otherwise; sets the sign value for the 2^{nd} sign-hidden transform coefficient to positive if the sign residual value of the 2^{nd} sign-hidden transform coefficient is 0 and negative otherwise; and sets the sign value for the 3^{rd} sign-hidden transform coefficient to positive if the sign residual value of the 3^{rd} sign-hidden transform coefficient is 0 and negative otherwise.
If the video decoder selects hypothesis reconstruction H010, the video decoder sets the sign value for the 1^{st} sign-hidden transform coefficient to positive if the sign residual value of the 1^{st} sign-hidden transform coefficient is 0 and negative otherwise; sets the sign value for the 2^{nd} sign-hidden transform coefficient to negative if the sign residual value of the 2^{nd} sign-hidden transform coefficient is 0 and positive otherwise; and sets the sign value for the 3^{rd} sign-hidden transform coefficient to positive if the sign residual value of the 3^{rd} sign-hidden transform coefficient is 0 and negative otherwise.
If the video decoder selects hypothesis reconstruction H011, the video decoder sets the sign value for the 1^{st} sign-hidden transform coefficient to negative if the sign residual value of the 1^{st} sign-hidden transform coefficient is 0 and positive otherwise; sets the sign value for the 2^{nd} sign-hidden transform coefficient to negative if the sign residual value of the 2^{nd} sign-hidden transform coefficient is 0 and positive otherwise; and sets the sign value for the 3^{rd} sign-hidden transform coefficient to positive if the sign residual value of the 3^{rd} sign-hidden transform coefficient is 0 and negative otherwise.
If the video decoder selects hypothesis reconstruction H100, the video decoder sets the sign value for the 1^{st} sign-hidden transform coefficient to positive if the sign residual value of the 1^{st} sign-hidden transform coefficient is 0 and negative otherwise; sets the sign value for the 2^{nd} sign-hidden transform coefficient to positive if the sign residual value of the 2^{nd} sign-hidden transform coefficient is 0 and negative otherwise; and sets the sign value for the 3^{rd} sign-hidden transform coefficient to negative if the sign residual value of the 3^{rd} sign-hidden transform coefficient is 0 and positive otherwise.
If the video decoder selects hypothesis reconstruction H101, the video decoder sets the sign value for the 1^{st} sign-hidden transform coefficient to negative if the sign residual value of the 1^{st} sign-hidden transform coefficient is 0 and positive otherwise; sets the sign value for the 2^{nd} sign-hidden transform coefficient to positive if the sign residual value of the 2^{nd} sign-hidden transform coefficient is 0 and negative otherwise; and sets the sign value for the 3^{rd} sign-hidden transform coefficient to negative if the sign residual value of the 3^{rd} sign-hidden transform coefficient is 0 and positive otherwise.
If the video decoder selects hypothesis reconstruction H110, the video decoder sets the sign value for the 1^{st} sign-hidden transform coefficient to positive if the sign residual value of the 1^{st} sign-hidden transform coefficient is 0 and negative otherwise; sets the sign value for the 2^{nd} sign-hidden transform coefficient to negative if the sign residual value of the 2^{nd} sign-hidden transform coefficient is 0 and positive otherwise; and sets the sign value for the 3^{rd} sign-hidden transform coefficient to negative if the sign residual value of the 3^{rd} sign-hidden transform coefficient is 0 and positive otherwise.
If the video decoder selects hypothesis reconstruction H111, the video decoder sets the sign value for the 1^{st} sign-hidden transform coefficient to negative if the sign residual value of the 1^{st} sign-hidden transform coefficient is 0 and positive otherwise; sets the sign value for the 2^{nd} sign-hidden transform coefficient to negative if the sign residual value of the 2^{nd} sign-hidden transform coefficient is 0 and positive otherwise; and sets the sign value for the 3^{rd} sign-hidden transform coefficient to negative if the sign residual value of the 3^{rd} sign-hidden transform coefficient is 0 and positive otherwise.

For a transform coefficient with a larger magnitude, the sign prediction is generally giving a better chance to achieve a correct prediction. In other words, the sign predictions of transform coefficients are more likely to be correct for larger transform coefficients than smaller transform coefficients. This is because an incorrect sign prediction for a transform coefficient with larger magnitude typically shows more discrepancy on the boundary sample smoothness. A video decoder, such as video decoder 300, as part of its parsing process, parses coefficients, signs and sign residues. The signs and sign residues are parsed at the end of the TU, and at that time the video decoder has determined the absolute values of all coefficients. Thus, the video decoder can determine what signs are predicted and, for each predicted sign, the video decoder can determine the context to use to parse the sign prediction residue based on the dequantized coefficient value.

With sign prediction, instead of coding the explicit sign value, the correctness of sign prediction is coded. For example, for predicting a coefficient sign which actually has a positive value, if the predicted sign is also positive, i.e., the sign prediction is correct, a ‘0’ bin is coded. Otherwise, if the predicted sign is negative, i.e., the sign prediction is not correct, a ‘1’ bin is coded. In this way, a video coder may utilize the level value (magnitude) of the transform coefficient as the context for coding the correctness of sign prediction, since a larger magnitude of transform coefficient leans to a higher chance of ‘0’ bin.

The existing sign prediction method utilizes one of two CABAC contexts to signal a particular sign prediction. In the existing sign prediction method, the CABAC context to use is determined based on whether or not the associated dequantized coefficient is lower or higher than a threshold. Therefore, for each quantized coefficient (or called quantized level) received by video decoder 300, video decoder 300 applies de-quantization to obtain the de-quantization coefficient to determine which context is used to decode its sign prediction bin. This de-quantization process introduces interaction between the CABAC parsing of the sign prediction and delta QP in the design of WET-D0031 because the CABAC decoding of the delta QP is put after the decoding of sign prediction. However, this decoding order may result in decoding errors because the decoding of the sign prediction needs the QP information.

In accordance with the techniques of this disclosure, a video coder such as video encoder 200 or video decoder 300 may determine the CABAC context according to the value of the quantized coefficient (or called quantization level) instead of the dequantized coefficient. With this modification, dequantization is no longer needed during CABAC decoding of the sign prediction information. As discussed above, this may potentially accelerate the decoding process, avoid decoding errors, and limit the complexity of the video decoder

In one example, a quantized coefficient that is larger than or equal to a predefined threshold will use a high probability context while the quantized coefficient which is smaller than a predefined threshold will use a low probability context to decode the sign prediction bin. In this example, the high probability context specifies a greater probability of sign residual value being 0 than the low probability context. The predefined threshold can be signaled at a SPS, PPS, slice header, CU level, TU level or implicitly determined at video encoder 200 and video decoder 300. In one example, this threshold is set to 1 implicitly for both video encoder 200 and video decoder 300.

In one example, this threshold is implicitly determined (e.g., by video encoder 200 and/or video decoder 300) based on the number of significant flags, the number of level-greater-than-one flags, the number for level-greater-than-two flags, and the positions of those flags in the transform domain (may be in scan order). A significant flag indicates whether a transform coefficient is non-zero; a level-greater-than-one flag indicates whether an absolute value of a transform coefficient is greater than 1; a level-greater-than-two flag indicates whether an absolute value of a transform coefficient is greater than 2. In this example, there may be a larger threshold if the number of level-greater-than-1 flags and level-greater-than-2 flags is large. For example, the threshold may be equal to 2 if there are more than 4 coefficients larger than 2 and the threshold may be equal to 1 otherwise.

Thus, in one example, a video coder (e.g., video encoder 200 or video decoder 300) may determine a predicted sign value for a transform coefficient of a current block of a current picture of the video data. Additionally, in this example, the video coder may determine, based on a quantized value for the transform coefficient being greater or less than a threshold, a CABAC context. In this example, the video coder may use the determined CABAC context to CABAC code (i.e., CABAC encode or CABAC decode) a syntax element indicating whether the predicted sign value for the transform coefficient is correct. If the predicted sign value for the transform coefficient is correct, the video coder may use the predicted sign value as the sign value for the transform coefficient. Otherwise, the video coder may use an opposite sign from the predicted sign value as the sign value for the transform coefficient.

In some examples, as part of determining the CABAC context, the video coder may, based on the quantized value for the transform coefficient being greater than or equal to the threshold, determine that the CABAC context is a first CABAC context. In this example, based on the quantized value for the transform coefficient being less than the threshold, the video coder may determine that the CABAC context is a second CABAC context. In this example, the first CABAC context has a higher probability than the second CABAC context. For instance, the first CABAC context may specify a greater probability of the sign residual value being 0 than the second CABAC context.

In some examples, video encoder 200 and video decoder 300 adaptively determine the threshold according to coding information such as the height and width of current CU, PU or TU. In one example, video encoder 200 and video decoder 300 set the threshold equal to N/(W*H) where N is any floating number, and W and H are the width and height, respectively, of the TU.

As noted elsewhere in this disclosure, a video coder identifies (i.e., collects) a given number n of transform coefficients in a TU for which to perform sign value prediction. For instance, as proposed in JVET-D0031, the video coder scans the dequantized transform coefficients of a TU in a raster-scan order and selects the first n scanned dequantized transform coefficients that have absolute values above a defined threshold. However, use of the raster scan order may not be consistent with the scanning order of transform coefficients used in generating and parsing syntax elements representing quantized transform coefficients. For instance, as described with respect to FIG. 2, a video coder uses a reverse diagonal scan in HEVC when generating and parsing syntax elements representing quantized transform coefficients. Using different scanning orders to collect transform coefficients for which to perform sign value prediction and generating/parsing syntax elements may increase the complexity of the video coder (e.g., require additional circuitry), which may increase the power consumption and/or size of processing circuitry that implements the video coder. Hence, in an example of this disclosure, when collecting the n coefficients for sign value prediction, the coefficients are scanned in a pre-defined scan order, such as zigzag scan in AVC or diagonal scan in HEVC, and dequantized values over a defined threshold are preferred over values lower than that threshold. In this way, by making the scanning orders consistent, the complexity of the video coder may be reduced.

Furthermore, in some examples, when collecting the n transform coefficients for sign value prediction, the transform coefficients are scanned in the same order as the coefficients scanning, and dequantized values over a defined threshold are preferred over values lower than that threshold.

In some examples, when collecting the n coefficients for sign prediction, the non-zero DC coefficient is always selected for sign prediction. In general, the DC coefficient is more representative for coefficients in the current block, and therefore is typically more helpful in sign prediction.

Thus, in some examples, a video coder may determine a plurality of dequantized transform coefficients in a transform block. The plurality of dequantized transform coefficients may consist of n dequantized transform coefficients, where n is an integer (e.g., n is an integer greater than 0 and less than the number of dequantized transform coefficients in the transform block). Additionally, in this example, as part of determining the plurality of dequantized transform coefficients, the video coder may scan dequantized transform coefficients in the transform block according to a scanning order to identify dequantized transform coefficients greater than a second threshold. Furthermore, in this example, the video coder may determine a plurality of hypothesis reconstructions. Each of the hypothesis reconstructions may be a set of reconstructed sample values reconstructed based on a different combination of sign values for the plurality of dequantized transform coefficients. For instance, in Table 2, hypothesis reconstruction H000 is a set of reconstructed sample values reconstructed based on combination of +, +, + for the three sign-hidden transform coefficients; hypothesis reconstruction H001 is a set of reconstructed sample values reconstructed based on the combination of −, +, +; hypothesis reconstruction H010 is a set of reconstructed sample values reconstructed based on the combination of −, −, +; and so on. In this example, the video coder may determine, based on cost values for the plurality of hypothesis reconstructions, a particular hypothesis reconstruction. For instance, the video coder may determine the cost values for the plurality of hypothesis reconstructions using equation (1), above. The particular hypothesis reconstruction may include the predicted sign value for the transform coefficient. In this example, the scanning order may be one of a zigzag scan order or a diagonal scan order. In some examples, the scanning order is the same as a coefficient scanning order. Furthermore, in some examples, as part of determining the plurality of dequantized transform coefficients, the video coder may always determine that a DC coefficient of the transform block is among the plurality of dequantized transform coefficients.

In some examples, the sign prediction syntax should be parsed after the delta QP information. This may be another way to avoid problems associated with selecting a CABAC context for sign residual values based on delta QP information occurring later in the bitstream than the sign residual values.

This disclosure may generally refer to “signaling” certain information, such as syntax elements. The term “signaling” may generally refer to the communication of values syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

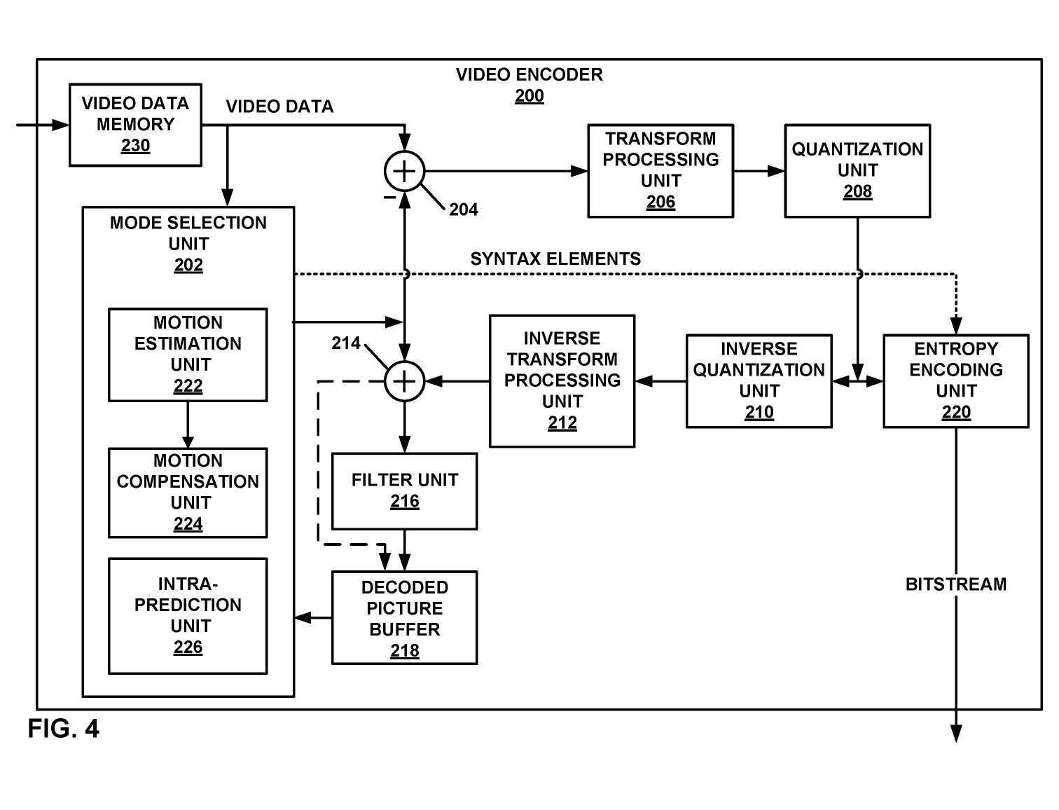

FIG. 4 is a block diagram illustrating an example video encoder 200 that may perform the techniques of this disclosure. FIG. 4 is provided for purposes of explanation and should not be considered limiting of the techniques as broadly exemplified and described in this disclosure. For purposes of explanation, this disclosure describes video encoder 200 in the context of video coding standards such as the HEVC video coding standard and the H.266/VVC video coding standard in development. However, the techniques of this disclosure are not limited to these video coding standards and are applicable generally to video encoding and decoding.

In the example of FIG. 4, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 4 are illustrated to assist with understanding the operations performed by video encoder 200. The units may be implemented as processing circuitry, such as fixed-function circuits, programmable circuits, or a combination thereof. Fixed-function circuits refer to circuits that provide particular functionality and are preset on the operations that can be performed. Programmable circuits refer to circuits that can programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, the one or more of the units may be distinct circuit blocks (fixed-function or programmable), and in some examples, the one or more units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the object code of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs and encapsulate one or more CTUs within a slice. Mode selection unit 202 may partition a CTU of the picture in accordance with a tree structure, such as the QTBT structure or the quad-tree structure of HEVC described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

Mode selection unit 202 provides the prediction block to residual generation unit 204. Residual generation unit 204 receives a raw, uncoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 20 and video decoder 30 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. As illustrated by dashed lines, operations of filter unit 216 may be skipped in some examples.

Video encoder 200 stores reconstructed blocks in DPB 218. For instance, in examples where operations of filter unit 216 are not needed, reconstruction unit 214 may store reconstructed blocks to DPB 218. In examples where operations of filter unit 216 are needed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding blocks and the chroma coding blocks.

Video encoder 200 represents an example of a device configured to encode video data including a memory configured to store video data, and one or more processing units implemented in circuitry and configured to perform techniques of this disclosure. For example, entropy encoding unit 220 may determine a predicted sign value for a transform coefficient of a current block of a current picture of the video data. In this example, entropy encoding unit 220 may determine, based on a quantized value for the transform coefficient being greater or less than a threshold, a CABAC context. Additionally, in this example, entropy encoding unit 220 may use the determined CABAC context to CABAC encode a syntax element (e.g., a sign residual value) indicating whether the predicted sign value for the transform coefficient is correct. In some examples, quantization unit 208 may quantize the transform coefficient of the current block to generate the quantized value for the transform coefficient and entropy encoding unit 220 may include the CABAC coded syntax element in a bitstream that comprises an encoded representation of the video data.

Furthermore, in some examples, as part of determining the CABAC context, entropy encoding unit 220 may, based on the quantized value for the transform coefficient being greater than or equal to the threshold, determine that the CABAC context is a first CABAC context of a set of CABAC contexts that includes the first CABAC context and a second CABAC context. In this example, the first CABAC context has a higher probability than the second CABAC context. Furthermore, in this example, based on the quantized value for the transform coefficient being less than the threshold, entropy encoding unit 220 may determine that the CABAC context is the second CABAC context. In some examples, entropy encoding unit 220 adaptively determines the threshold based on coding information. Such coding information may comprise at least one of a width and height of a current coding unit, prediction unit, or transform unit.

Additionally, in such examples, quantization unit 208 may quantize the transform coefficient of the current block to generate the quantized value for the transform coefficient. In this example, entropy encoding unit 220 may include the CABAC coded syntax element in a bitstream that comprises an encoded representation of the video data. In some examples, entropy encoding unit 220 may use one or more additional syntax elements in one or more of a SPS, a PPS, a slice header, a coding unit syntax structure, or a transform unit syntax structure to signal the threshold used for determining the CABAC contexts for the sign residual values.

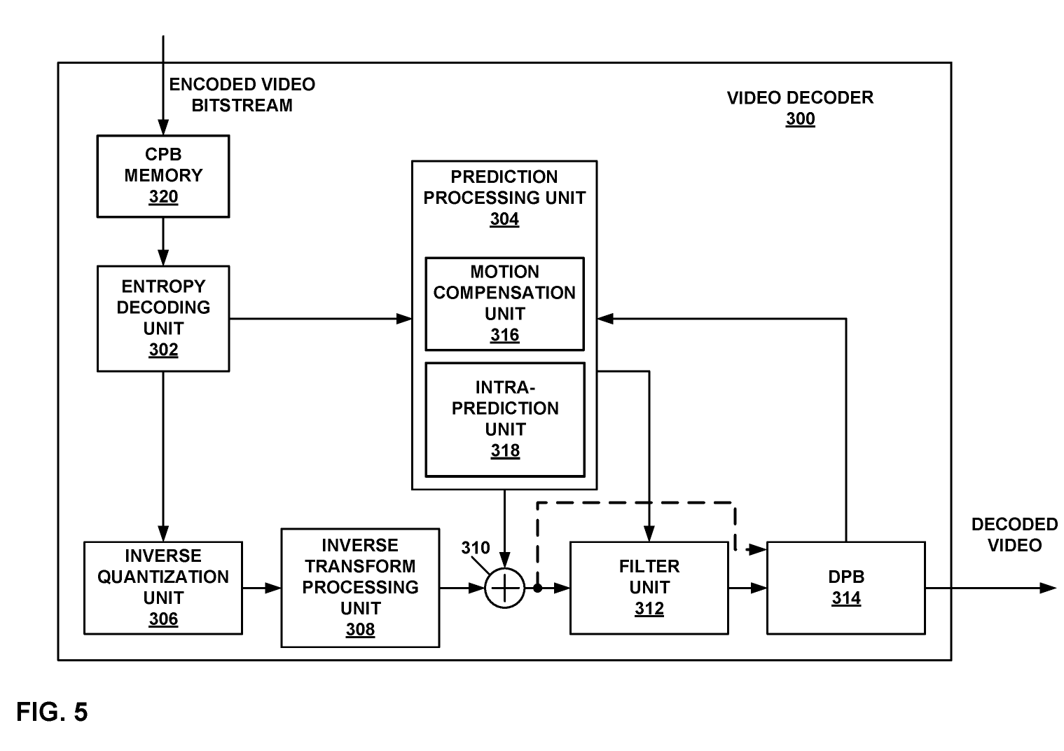

FIG. 5 is a block diagram illustrating an example video decoder 300 that may perform the techniques of this disclosure. FIG. 5 is provided for purposes of explanation and is not limiting on the techniques as broadly exemplified and described in this disclosure. For purposes of explanation, this disclosure describes video decoder 300 according to the techniques of JEM and HEVC. However, the techniques of this disclosure may be performed by video coding devices that are configured to other video coding standards.

In the example of FIG. 5, video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. Prediction processing unit 304 includes motion compensation unit 316 and intra-prediction unit 318. Prediction processing unit 304 may include addition units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as dynamic random access memory (DRAM), including synchronous DRAM (SDRAM), magnetoresistive RAM (MRAM), resistive RAM (RRAM), or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 5 are illustrated to assist with understanding the operations performed by video decoder 300. The units of video decoder 300 may be implemented as processing circuitry, such as fixed-function circuits, programmable circuits, or a combination thereof. Similar to FIG. 4, fixed-function circuits refer to circuits that provide particular functionality, and are preset on the operations that can be performed. Programmable circuits refer to circuits that can programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, the one or more of the units may be distinct circuit blocks (fixed-function or programmable), and in some examples, the one or more units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 4).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 4). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. As illustrated by dashed lines, operations of filter unit 312 are not necessarily performed in all examples.

Video decoder 300 may store the reconstructed blocks in DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures from DPB for subsequent presentation on a display device, such as display device 118 of FIG. 1.

In this manner, video decoder 300 represents an example of a video decoding device including a memory configured to store video data, and one or more processing units implemented in circuitry (i.e., processing circuitry) configured to perform techniques of this disclosure. For example, entropy decoding unit 302 may determine a predicted sign value for a transform coefficient of a current block of a current picture of the video data. In this example, entropy decoding unit 302 may determine, based on a quantized value for the transform coefficient being greater or less than a threshold, a CABAC context. Additionally, entropy decoding unit 302 may use the determined CABAC context to CABAC code a syntax element indicating whether the predicted sign value for the transform coefficient is correct.

In one example, as part of determining the CABAC context, entropy decoding unit 302 may, based on the quantized value for the transform coefficient being greater than or equal to the threshold, determine that the CABAC context is a first CABAC context of a set of CABAC contexts that includes the first CABAC context and a second CABAC context. In this example, the first CABAC context has a higher probability than the second CABAC context. In this example, based on the quantized value for the transform coefficient being less than the threshold, entropy decoding unit 302 may determine that the CABAC context is the second CABAC context. In some examples, entropy decoding unit 302 may adaptively determine the threshold based on coding information. Such coding information may include at least one of a width and height of a current CU, PU, or TU.

Furthermore, in some examples, entropy decoding unit 302 may obtain the syntax element from a bitstream that comprises an encoded representation of the video data. Additionally, inverse quantization unit 306 may inverse quantize the quantized value for the transform coefficient to determine an inverse quantized value for the transform coefficient. Inverse quantization unit 306 or another unit of video decoder 300 may set a sign value for the inverse quantized value for the transform coefficient to the predicted sign value for the transform coefficient based on the syntax element indicating that the predicted sign value for the transform coefficient is correct. For instance, inverse quantization unit 306 may set the sign value for the inverse quantized transform coefficient to the predicted sign value if the syntax element indicates that the predicted sign value for the transform coefficient is correct and may set the sign value for the inverse quantized transform coefficient to the opposite of the predicted sign value if the syntax element indicates that the predicted sign value for the transform coefficient is incorrect. Inverse transform processing unit 308 may apply a transform to the inverse quantized value for the transform coefficient to generate a residual value. Furthermore, reconstruction unit 310 may reconstruct the current block based in part on the residual value. For instance, reconstruction unit 310 may reconstruct a value of a sample of the current block by adding the residual value to a sample value in a prediction block generated by prediction processing unit 304.

In some examples, entropy decoding unit 302 determines the threshold based on one or more syntax elements signaled in one or more of a SPS, a PPS, a slice header, a coding unit syntax structure, a transform unit syntax structure, or another syntax structure. Additionally, in some examples, entropy decoding unit 302 may parse delta QP information from the bitstream. In this example, after parsing the delta QP information from the bitstream, entropy decoding unit 302 may parse the syntax element from the bitstream. Parsing the syntax element from the bitstream may include CABAC decoding the syntax element in the manner described elsewhere in this disclosure.

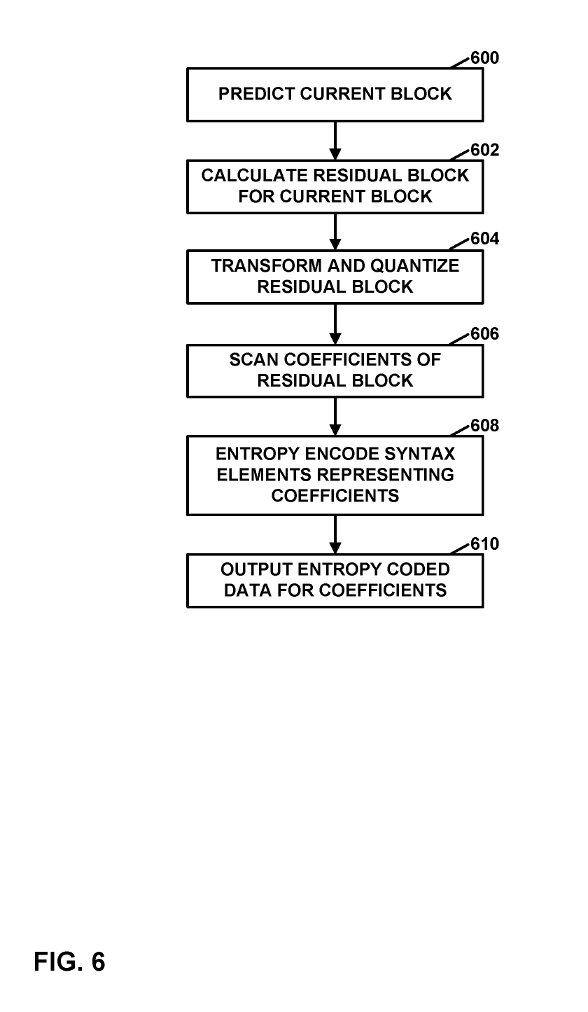

FIG. 6 is a flowchart illustrating an example method for encoding a current block. The current block may be or may include a current CU. Although described with respect to video encoder 200 (FIGS. 1 and 2), it should be understood that other devices may be configured to perform a method similar to that of FIG. 6.

In this example, video encoder 200 initially predicts the current block (600). For example, video encoder 200 may form a prediction block for the current block. Video encoder 200 may then calculate a residual block for the current block (602). To calculate the residual block, video encoder 200 may calculate a difference between the original, uncoded block and the prediction block for the current block. Video encoder 200 may then transform and quantize coefficients of the residual block (604). Next, video encoder 200 may scan the quantized transform coefficients of the residual block (606). During the scan, or following the scan, video encoder 200 may entropy encode the coefficients (408). For example, video encoder 200 may encode the coefficients using CAVLC or CABAC. In accordance with a technique of this disclosure, as part of video encoder 200 entropy encoding the syntax elements representing the transform coefficients, video encoder 200 may determine a predicted sign value for a transform coefficient of a current block of a current picture of the video data. Additionally, video encoder 200 may determine, based on a quantized value for the transform coefficient being greater or less than a threshold, a CABAC context. Video encoder 200 may use the determined CABAC context to CABAC encode a syntax element indicating whether the predicted sign value for the transform coefficient is correct. Video encoder 200 may then output the entropy encoded data of the block (610).

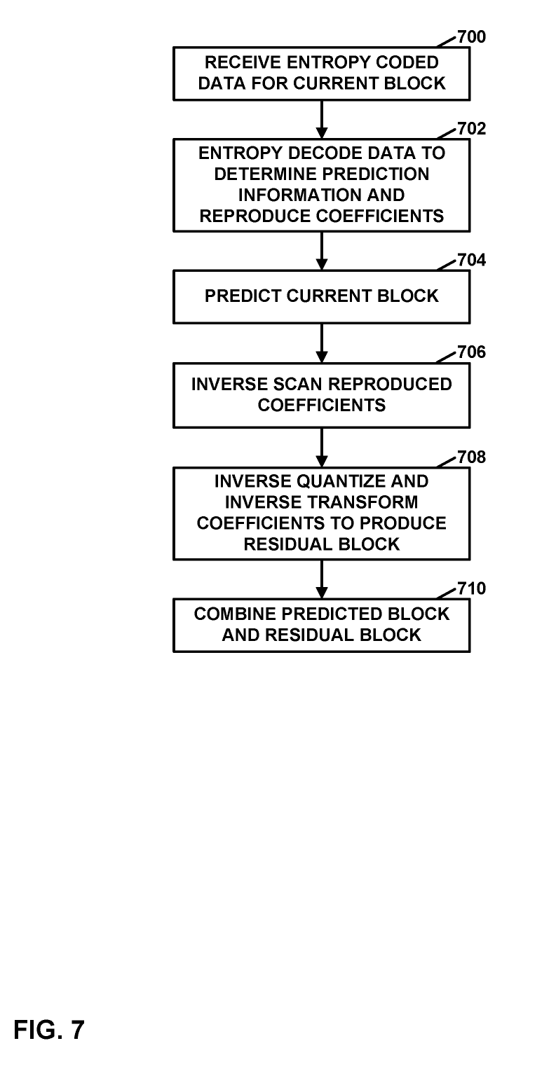

FIG. 7 is a flowchart illustrating an example method for decoding a current block of video data. The current block may be or may include a current CU. Although described with respect to video decoder 300 (FIGS. 1 and 5), it should be understood that other devices may be configured to perform a method similar to that of FIG. 7.

Video decoder 300 may receive entropy coded data for the current block, such as entropy coded prediction information and entropy coded data for transform coefficients of a residual block corresponding to the current block (700). Video decoder 300 may entropy decode the entropy coded data to determine prediction information for the current block and to reproduce transform coefficients of the residual block (702).

In accordance with a technique of this disclosure, as part of video decoder 300 entropy decoding the syntax elements representing the transform coefficients, video decoder 300 may determine a predicted sign value for a transform coefficient of a current block of a current picture of the video data. Additionally, video decoder 300 may determine, based on a quantized value for the transform coefficient being greater or less than a threshold, a CABAC context. Video decoder 300 may use the determined CABAC context to CABAC decode a syntax element indicating whether the predicted sign value for the transform coefficient is correct.

Video decoder 300 may predict the current block (704), e.g., using an intra- or inter-prediction mode as indicated by the prediction information for the current block, to calculate a prediction block for the current block. Video decoder 300 may then inverse scan the reproduced transform coefficients (806), to create a block of quantized transform coefficients. Video decoder 300 may then inverse quantize and inverse transform the transform coefficients to produce a residual block (708). Video decoder 300 may ultimately decode the current block by combining the prediction block and the residual block (710).

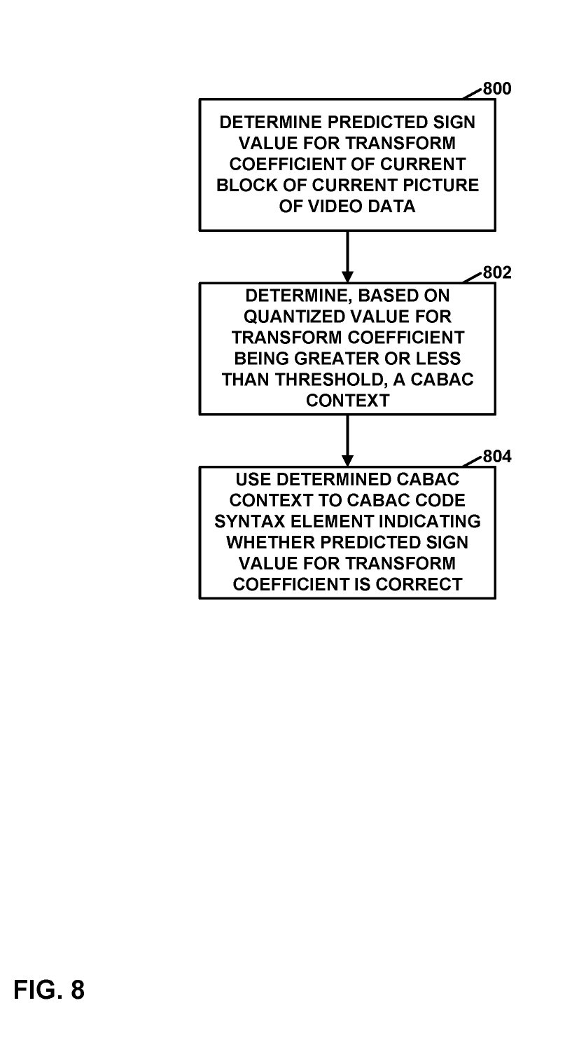

FIG. 8 is a flowchart illustrating an example process for CABAC coding sign residual values in accordance with an example of this disclosure. Video encoder 200 may perform the process of FIG. 8 as part of step (608) of FIG. 6. For instance, the syntax elements representing coefficients in step (608) of FIG. 6 may include CABAC encoded sign residual values (i.e., syntax elements indicating whether predicted sign values for transform coefficients are correct). Video encoder 200 may perform the process of FIG. 8 to CABAC encode the sign residual values.

Video decoder 300 may perform the process of FIG. 8 as part of step (702) of FIG. 7. For instance, the entropy encoded syntax elements received in step (700) of FIG. 7 may include CABAC-encoded sign residual values (i.e., syntax elements indicating whether predicted sign values for transform coefficients are correct). Video decoder 300 may perform the process of FIG. 8 to CABAC decode the received CABAC-encoded sign residual values.

In the example of FIG. 8, a video coder (e.g., video encoder 200 or video decoder 300) may determine a predicted sign value for a transform coefficient of a current block of a current picture of the video data (800). The video coder may determine the predicted sign value in accordance with any of the examples provided elsewhere in this disclosure.

Additionally, in the example of FIG. 8, the video coder determines, based on a quantized value for the transform coefficient being greater or less than a threshold, a CABAC context (802). For example, the video coder may determine that the CABAC context is a first CABAC context if the quantized value for the transform coefficient is greater than or equal to the threshold and may determine that the CABAC context is a second, different CABAC context if the quantized value for the transform coefficient is less than the threshold. In this example, the first and second CABAC contexts may specify different sets of probabilities. The quantized value for a transform coefficient is a version of the transform coefficient that has been quantized. In some examples, the threshold may be set to 1. In other examples, the threshold may have different values. For instance, the video coder may adapt the threshold according to coding information such as the height and width of current CU, PU or TU, as described elsewhere in this disclosure.

In the example of FIG. 8, the video coder uses the determined CABAC context to CABAC code a syntax element indicating whether the predicted sign value for the transform coefficient is correct (804). For instance, if the video coder is video encoder 200, the video coder may use the determined CABAC context to CABAC encode the syntax element. If the video coder is video decoder 300, the video code may use the determined CABAC context to CABAC decode the syntax element. An example process of using a CABAC context to CABAC code a syntax element is described elsewhere in this disclosure.

The following text provides examples in accordance with the techniques of this disclosure. The examples below are not an exhaustive list of examples or combinations thereof.

### Example 1

A method of coding video data, the method comprising:

determining a predicted sign value for a transform coefficient of a current block of a current picture of the video data; determining, based on a quantized value for the transform coefficient being greater or less than a threshold, a Context Adaptive Binary Arithmetic Coding (CABAC) context; using the determined CABAC context to CABAC code a syntax element indicating whether the predicted sign value for the transform coefficient is correct.

### Example 2

The method of example 1, wherein determining the CABAC context comprises one of: based on the quantized value for the transform coefficient being greater than or equal to the threshold, determining that the CABAC context is a first CABAC context of a set of CABAC contexts that includes the first CABAC context and a second CABAC context, the first CABAC context having a higher probability than the second CABAC context; and based on the quantized value for the transform coefficient being less than the threshold, determining that the CABAC context is the second CABAC context.

### Example 3

The method of any of examples 1-2, further comprising: adaptively determining the threshold based on coding information.

### Example 4

The method of example 3, wherein the coding information comprises at least one of a width and height of a current coding unit, prediction unit, or transform unit.

### Example 5

The method of any of examples 1-4, wherein the threshold is a first threshold, and determining the predicted sign value for the transform coefficient comprises: determining a plurality of dequantized transform coefficients in a transform block, the plurality of dequantized transform coefficients consisting of n dequantized transform coefficients, wherein determining the plurality of dequantized transform coefficients comprises scanning dequantized transform coefficients in the transform block according to a scanning order to identify dequantized transform coefficients greater than a second threshold; determining a plurality of hypothesis reconstructions, each of the hypothesis reconstructions being a set of reconstructed sample values reconstructed based on a different combination of sign values for the plurality of dequantized transform coefficients; and determining, based on cost values for the plurality of hypothesis reconstructions, a particular hypothesis reconstruction, wherein the combination of sign values upon which the particular hypothesis reconstruction is based includes the predicted sign value for the transform coefficient.

### Example 6

The method of example 5, wherein the scanning order is one of a zigzag scan order or a diagonal scan order.

### Example 7

The method of any of examples 5-6, wherein determining the plurality of dequantized transform coefficients comprises always determining that a DC coefficient of the transform block is among the plurality of dequantized transform coefficients.

### Example 8

The method of any of examples 5-6, wherein the scanning order is the same as a coefficient scanning order.

### Example 9

The method of any of examples 1-8, wherein coding comprises decoding.

### Example 10

The method of example 9, further comprising: obtaining the syntax element from a bitstream that comprises an encoded representation of the video data; inverse quantizing the quantized value for the transform coefficient to determine an inverse quantized value for the transform coefficient; setting a sign value for the inverse quantized value for the transform coefficient to the predicted sign value for the transform coefficient based on the syntax element indicating that the predicted sign value for the transform coefficient is correct; applying a transform to the inverse quantized value for the transform coefficient to generate a residual value; and reconstructing the current block based in part on the residual value.

### Example 11

The method of any of examples 9-10, further comprising:
determining the threshold based on one or more syntax elements signaled in one or more of a Sequence Parameter Set, a Picture Parameter Set, a slice header, a coding unit syntax structure, or a transform unit syntax structure.

### Example 12

The method of any of examples 9-11, further comprising: parsing delta Quantization Parameter (QP) information from a bitstream that comprises an encoded representation of the video data; and after parsing the delta QP information from the bitstream, parsing the syntax element from the bitstream.

### Example 13

The method of any of examples 1-8, wherein coding comprises encoding.

### Example 14

The method of example 13, further comprising: quantizing the transform coefficient of the current block to generate the quantized value for the transform coefficient; and including the CABAC coded syntax element in a bitstream that comprises an encoded representation of the video data.

### Example 15

The method of any of examples 13-14, further comprising: using one or more additional syntax elements in one or more of a Sequence Parameter Set, a Picture Parameter Set, a slice header, a coding unit syntax structure, or a transform unit syntax structure to signal the threshold.

### Example 16

A device for coding video data, the device comprising one or more means for performing the method of any of examples 1-15.

### Example 17

The device of example 16, wherein the one or more means comprise one or more processors implemented in circuitry.

### Example 18

The device of any of examples 16-17, further comprising a memory to store the video data.

### Example 19

The device of any of examples 16-18, further comprising a display configured to display decoded video data.

### Example 20

The device of any of examples 16-19, wherein the device comprises one or more of a camera, a computer, a mobile device, a broadcast receiver device, or a set-top box.

### Example 21

The device of any of examples 16-20, wherein the device comprises a video decoder.

### Example 22

The device of any of examples 17-21, wherein the device comprises a video encoder.

### Example 23

A computer-readable storage medium having stored thereon instructions that, when executed, cause one or more processors to perform the method of any of examples 1-15.

### Example 24

A device for encoding video data, the device comprising means for performing the methods of any of examples 1-15.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” or “processing circuitry” as used herein may refer to any of the foregoing types of integrated or discrete logic circuitry suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of coding video data, the method comprising:
determining a predicted sign value for a transform coefficient of a current block of a current picture of the video data;
determining, based on a quantized value for the transform coefficient being greater or less than a threshold, a Context Adaptive Binary Arithmetic Coding (CABAC) context; and
using the determined CABAC context to CABAC code a syntax element indicating whether the predicted sign value for the transform coefficient is correct.

2. The method of claim 1, wherein determining the CABAC context comprises one of:
based on the quantized value for the transform coefficient being greater than or equal to the threshold, determining that the CABAC context is a first CABAC context of a set of CABAC contexts that includes the first CABAC context and a second CABAC context; and
based on the quantized value for the transform coefficient being less than the threshold, determining that the CABAC context is a second CABAC context, wherein the first CABAC context has a higher probability than the second CABAC context.

3. The method of claim 1, further comprising:
adaptively determining the threshold based on coding information.

4. The method of claim 3, wherein the coding information comprises at least one of a width and height of a current coding unit, prediction unit, or transform unit.

5. The method of claim 1, wherein the threshold is a first threshold, and determining the predicted sign value for the transform coefficient comprises:
determining a plurality of dequantized transform coefficients in a transform block, wherein determining the plurality of dequantized transform coefficients comprises the scanning dequantized transform coefficients in the transform block according to a scanning order to identify dequantized transform coefficients greater than a second threshold;
determining a plurality of hypothesis reconstructions, each of the hypothesis reconstructions being a set of reconstructed sample values reconstructed based on a different combination of sign values for the plurality of dequantized transform coefficients; and
determining, based on cost values for the plurality of hypothesis reconstructions, a particular hypothesis reconstruction, wherein the combination of sign values upon which the particular hypothesis reconstruction is based includes the predicted sign value for the transform coefficient.

6. The method of claim 5, wherein determining the plurality of dequantized transform coefficients comprises always determining that a DC coefficient of the transform block is among the plurality of dequantized transform coefficients.

7. The method of claim 1, wherein coding comprises decoding and the method further comprises:
obtaining the syntax element from a bitstream that comprises an encoded representation of the video data;
inverse quantizing the quantized value for the transform coefficient to determine an inverse quantized value for the transform coefficient;
setting a sign value for the inverse quantized value for the transform coefficient to the predicted sign value for the transform coefficient based on the syntax element indicating that the predicted sign value for the transform coefficient is correct;
applying a transform to the inverse quantized value for the transform coefficient to generate a residual value; and
reconstructing the current block based in part on the residual value.

8. The method of claim 1, wherein coding comprises decoding and the method further comprises:
determining the threshold based on one or more syntax elements signaled in one or more of a Sequence Parameter Set, a Picture Parameter Set, a slice header, a coding unit syntax structure, or a transform unit syntax structure.

9. The method of claim 1, wherein coding comprises encoding and the method further comprises:
quantizing the transform coefficient of the current block to generate the quantized value for the transform coefficient; and
including the CABAC coded syntax element in a bitstream that comprises an encoded representation of the video data.

10. The method of claim 1, wherein coding comprises encoding and the method further comprises:
using one or more additional syntax elements in one or more of a Sequence Parameter Set, a Picture Parameter Set, a slice header, a coding unit syntax structure, or a transform unit syntax structure to signal the threshold.

11. A device for coding video data, the device comprising:
a memory to store the video data; and
processing circuitry configured to:
determine a predicted sign value for a transform coefficient of a current block of a current picture of the video data;
determine, based on a quantized value for the transform coefficient being greater or less than a threshold, a Context Adaptive Binary Arithmetic Coding (CABAC) context; and
use the determined CABAC context to CABAC code a syntax element indicating whether the predicted sign value for the transform coefficient is correct.

12. The device of claim 11, wherein the processing circuitry is configured such that, as part of determining the CABAC context, the processing circuitry:
based on the quantized value for the transform coefficient being greater than or equal to the threshold, determines that the CABAC context is a first CABAC context of a set of CABAC contexts that includes the first CABAC context and a second CABAC context; and
based on the quantized value for the transform coefficient being less than the threshold, determines that the CABAC context is a second CABAC context, wherein the first CABAC context has a higher probability than the second CABAC context.

13. The device of claim 11, wherein the processing circuitry is further configured to adaptively determine the threshold based on coding information.

14. The device of claim 13, wherein the coding information comprises at least one of a width and height of a current coding unit, prediction unit, or transform unit.

15. The device of claim 11, wherein the threshold is a first threshold, and the processing circuitry is configured such that, as part of determining the predicted sign value for the transform coefficient, the processing circuitry:
determines a plurality of dequantized transform coefficients in a transform block, wherein determining the plurality of dequantized transform coefficients comprises scanning the dequantized transform coefficients in the transform block according to a scanning order to identify dequantized transform coefficients greater than a second threshold;
determines a plurality of hypothesis reconstructions, each of the hypothesis reconstructions being a set of reconstructed sample values reconstructed based on a different combination of sign values for the plurality of dequantized transform coefficients; and
determines, based on cost values for the plurality of hypothesis reconstructions, a particular hypothesis reconstruction, wherein the combination of sign values upon which the particular hypothesis reconstruction is based includes the predicted sign value for the transform coefficient.

16. The device of claim 15, wherein the processing circuitry is configured such that, as part of determining the plurality of dequantized transform coefficients, the processing circuitry always determines that a DC coefficient of the transform block is among the plurality of dequantized transform coefficients.

17. The device of claim 11, wherein the processing circuitry is configured to decode the video data and the processing circuitry is further configured to:
obtain the syntax element from a bitstream that comprises an encoded representation of the video data;
inverse quantize the quantized value for the transform coefficient to determine an inverse quantized value for the transform coefficient;
set a sign value for the inverse quantized value for the transform coefficient to the predicted sign value for the transform coefficient based on the syntax element indicating that the predicted sign value for the transform coefficient is correct;
apply a transform to the inverse quantized value for the transform coefficient to generate a residual value; and
reconstruct the current block based in part on the residual value.

18. The device of claim 11, wherein the processing circuitry is configured to decode the video data and the syntax element and the processing circuitry is further configured to:
determine the threshold based on one or more syntax elements signaled in one or more of a Sequence Parameter Set, a Picture Parameter Set, a slice header, a coding unit syntax structure, or a transform unit syntax structure.

19. The device of claim 11, wherein the processing circuitry is configured to encode the video data and the processing circuitry is further configured to:
quantize the transform coefficient of the current block to generate the quantized value for the transform coefficient; and
include the CABAC coded syntax element in a bitstream that comprises an encoded representation of the video data.

20. The device of claim 11, wherein the processing circuitry is configured to encode the video data and the processing circuitry is further configured to:
use one or more additional syntax elements in one or more of a Sequence Parameter Set, a Picture Parameter Set, a slice header, a coding unit syntax structure, or a transform unit syntax structure to signal the threshold.

21. The device of claim 11, further comprising a display configured to display decoded video data.

22. The device of claim 11, wherein the device comprises one or more of a camera, a computer, a mobile device, a broadcast receiver device, or a set-top box.

23. The device of claim 11, wherein the device comprises a video decoder or a video encoder.

24. A device for coding video data, the device comprising:
means for determining a predicted sign value for a transform coefficient of a current block of a current picture of the video data;
means for determining, based on a quantized value for the transform coefficient being greater or less than a threshold, a Context Adaptive Binary Arithmetic Coding (CABAC) context; and
means for using the determined CABAC context to CABAC code a syntax element indicating whether the predicted sign value for the transform coefficient is correct.

25. A computer-readable storage medium having stored thereon instructions that, when executed, cause one or more processors to:
determine a predicted sign value for a transform coefficient of a current block of a current picture of the video data;
determine, based on a quantized value for the transform coefficient being greater or less than a threshold, a Context Adaptive Binary Arithmetic Coding (CABAC) context; and
use the determined CABAC context to CABAC code a syntax element indicating whether the predicted sign value for the transform coefficient is correct.
